(19) United States
(12) Patent Application Publication
(10) Pub. No.: US 2010/0026598 A1
(43) Pub. Date: Feb. 4, 2010

(54) SATELLITE BROADCAST RECEIVING CONVERTER

(75) Inventors: Koji Yokoi, Nisshin-shi (JP); Takehito Kuno, Nisshin-shi (JP); Kenzi Suzuki, Nisshin-shi (JP); Toshihiro Sugiura, Nisshin-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: MASPRODENKOH KABUSHIKIKAISHA, Nisshin-shi (JP)

(21) Appl. No.: 12/593,729

(22) PCT Filed: Mar. 17, 2008
(86) PCT No.: PCT/JP2008/054886

§ 371 Date: Sep. 29, 2009

(30) Foreign Application Priority Data
Mar. 30, 2007 (JP) 2007-092555

(51) Int. Cl. H01Q 13/02

(52) U.S. Cl. 343/786

(57) ABSTRACT

A satellite broadcast receiving converter is provided with a feedhorn to which a satellite broadcast wave is input, a circuit board on which a converting circuit to convert the satellite broadcast wave to a receiving signal is formed, and a converter case disposed on a back end side of the feedhorn to support the circuit board. The converter case is comprised of two case members configured to cover and shield the front and back surfaces of the circuit board, and to be able to hold the circuit board. A first case member of the two case members is integrally formed with the feedhorn.

### TECHNICAL FIELD

The present invention relates to a satellite broadcast receiving converter disposed at a focal position of a parabolic reflector and used in receiving a satellite broadcast radio wave.

### BACKGROUND ART

Conventionally, in this type of a satellite broadcast receiving converter, a proposal has been made to form a feedhorn, for receiving the satellite broadcast radio wave, made of synthetic resin of which surface is plated with metal, or to form the feedhorn by pressing a metal plate, for weight reduction (see, for example, Patent Documents 1, 2, and so on).

### Patent Document 1: Unexamined Japanese Patent Publication No. 2001-119202

### Patent Document 2: Unexamined Japanese Patent Publication No. 10-233618

### DISCLOSURE OF THE INVENTION

### Problems to be Solved by the Invention

The above-proposed satellite broadcast receiving converter is configured to accommodate a converting circuit that receives a satellite broadcast radio wave and converts the satellite broadcast radio wave to a desired receiving signal in a shield housing. The housing is accommodated in a converter case made of synthetic resin together with the feedhorn or directly screwed on a back end side of the feedhorn.

According to the above-proposed satellite broadcast receiving converter, the weight of the feedhorn itself can be reduced. However, aside from the feedhorn, a circuit board of the converting circuit, a housing that accommodates the circuit board, a member (such as a converter case) for assembling the housing integrally with the feedhorn, become necessary. Therefore, the weight of the satellite broadcast receiving converter is unable to be sufficiently reduced. An increase in number of components also leads to an increase in costs.

The present invention is made so as to solve the above-described problems. One object of the invention is to reduce the number of components of the satellite broadcast receiving converter so as to reduce the weight and costs of the satellite broadcast receiving converter.

### Means for Solving the Problem

A first aspect of the invention which was made to achieve the above-described object provides a satellite broadcast receiving converter including a feedhorn, a circuit board, and a converter case. A satellite broadcast wave is input to the feedhorn. A converting circuit to convert the satellite broadcast wave to a receiving signal is formed on the circuit board. The converter case is disposed on a back end side of the feedhorn to support the circuit board. The converter case is constituted of two case members configured to cover and shield front and back surfaces of the circuit board, and to be able to hold the circuit board. A first case member of the two case members is integrally formed with the feedhorn.

A second aspect of the invention provides the satellite broadcast receiving converter according to the first aspect, wherein the feedhorn and the support case are integrally formed of synthetic resin. At least an inner side surface of the feedhorn and an inner side surface facing the circuit board of the first case member are plated with metal.

A third aspect of the invention provides the satellite broadcast receiving converter according to the first aspect, wherein the first case member and the feedhorn are integrally formed by forging.

A fourth aspect of the invention provides the satellite broadcast receiving converter according to one of the first to the third aspects, wherein at least an inner side surface facing the circuit board of a second case member of the two case members is formed of synthetic resin plated with metal.

A fifth aspect of the invention provides the satellite broadcast receiving converter according to one of the first to the third aspects, wherein a second case member of the two case members of the shield case is formed by forging.

A sixth aspect of the invention provides the satellite broadcast receiving converter according to one of the first to the fifth aspects, wherein an external conductor of a coaxial connector for outputting a received signal from the circuit board is integrally formed with the first case member integrally formed with the feedhorn.

### EFFECT OF THE INVENTION

In the satellite broadcast receiving converter according to the first aspect of the present invention, the converter case is constituted of the two case members which can hold and shield the circuit board from the front and back surface sides. Moreover, the first case member of the two case members is integrally formed with the feedhorn.

Thus, the satellite broadcast receiving converter is mainly constituted of three components, that is, the first case member integrally formed with the feedhorn, the circuit board, and the second case member that holds and shields the circuit board with the first case member.

According to the satellite broadcast receiving converter of the invention, the number of components can be reduced as compared to that of the conventional satellite broadcast receiving converter. Reduction of the weight and costs of the satellite broadcast receiving converter can be achieved.

In order to further reduce the weight of the satellite broadcast receiving converter, it is preferable that the first case member and the feedhorn are integrally formed of synthetic resin as in the second aspect of the invention, or the first case member and the feedhorn are integrally formed by forging (such as press work) as in the third aspect of the invention.

It is also preferable that the second case member is formed of synthetic resin as in the fourth aspect of the invention, or formed by forging (such as press work) as in the fifth aspect of the invention.

In this manner, the weight of the satellite broadcast receiving converter can be reduced as compared to a case of forming the first case member and the feedhorn, or the second case member, by casting.

In case that the first case member and the feedhorn are integrated with synthetic resin, it is necessary to plate at least the inner side surface of the feedhorn and the inner side surface facing the circuit board of the first case member with metal, so that a satellite broadcast radio wave can be received (see the second aspect).

Also, in case that the second case member is integrated with synthetic resin, it is necessary to plate the inner side surface of the feedhorn and the inner side surface facing the circuit board of the second case member with metal, so that the circuit board can be shielded by the second case member (see the fourth aspect).

The circuit board is for converting a satellite broadcast radio wave received via the feedhorn to a given received signal and outputs the signal. Accordingly, a terminal or a signal line for outputting the received signal is connected to the circuit board. Generally, a coaxial connector (F-type connector in general) is provided in the converter case of the satellite broadcast receiving converter as the terminal for outputting the received signal. However, such coaxial connector is heavy and costly since its external conductor portion for connector attachment is formed by processing metal.

Therefore, it is preferable that the external conductor of the coaxial connector for outputting the received signal from the circuit board is integrally formed with the first case member integrally formed with the feedhorn, as in the sixth aspect of the invention.

In this manner, the external conductor of the coaxial connector is integrally formed with the first case member. The coaxial connector can be provided in the converter case only by providing a terminal for center conductor connection on an inner side of the external conductor via an insulating member. As compared to the conventional case in which the connector is separately provided, the weight of the satellite broadcast receiving converter can be reduced.

In case that the external conductor is integrally formed with the first case member, it is necessary to plate the inner wall and outer wall of the external conductor with metal. Because, if the first case member is made of synthetic resin, the external conductor integrally formed with the first case member is also made of synthetic resin.

### BRIEF DESCRIPTION OF THE DRAWINGS

FIG. 1 is a perspective view showing a constitution of a receiving antenna according to an embodiment of the present invention;

FIG. 2 is an exploded perspective view showing a constitution of a converter according to the embodiment;

FIG. 3 is a sectional view showing the constitution of the converter according to the embodiment; and

FIG. 4 is a sectional view showing an example of other constitution of the converter.

### EXPLANATION OF REFERENTIAL NUMERALS

2 . . . receiving antenna, 4 . . . parabolic reflector, 6 . . . arm, 8 . . . converter, 10 . . . feedhorn, 12 . . . circuit board, 14 . . . first case member, 16 . . . second case member, 18 . . . connector portion, 19 . . . packing member.

### BEST MODE TO CARRY OUT THE INVENTION

Hereinafter, an embodiment of the present invention will be described by way of drawings.

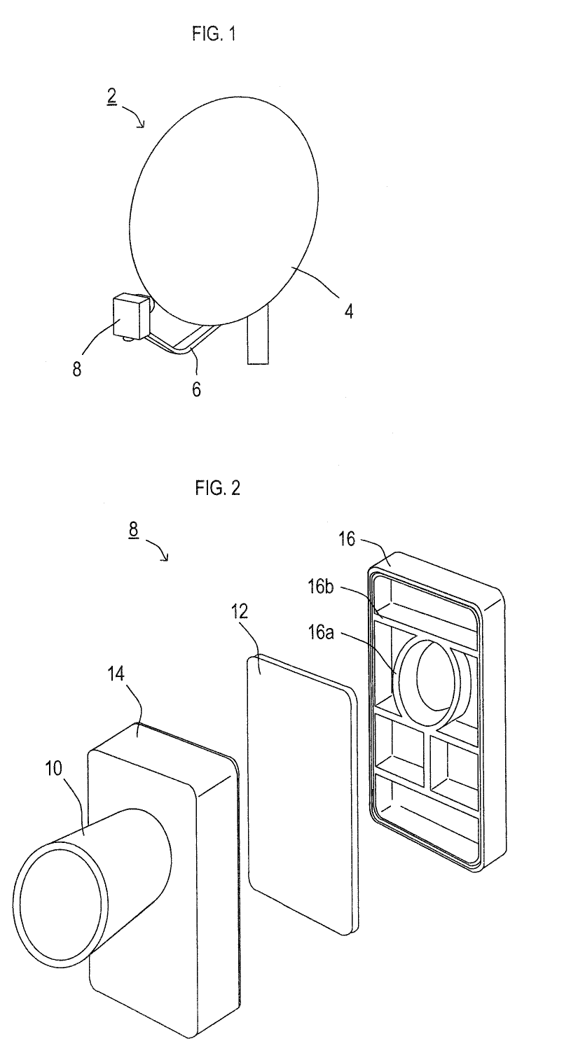

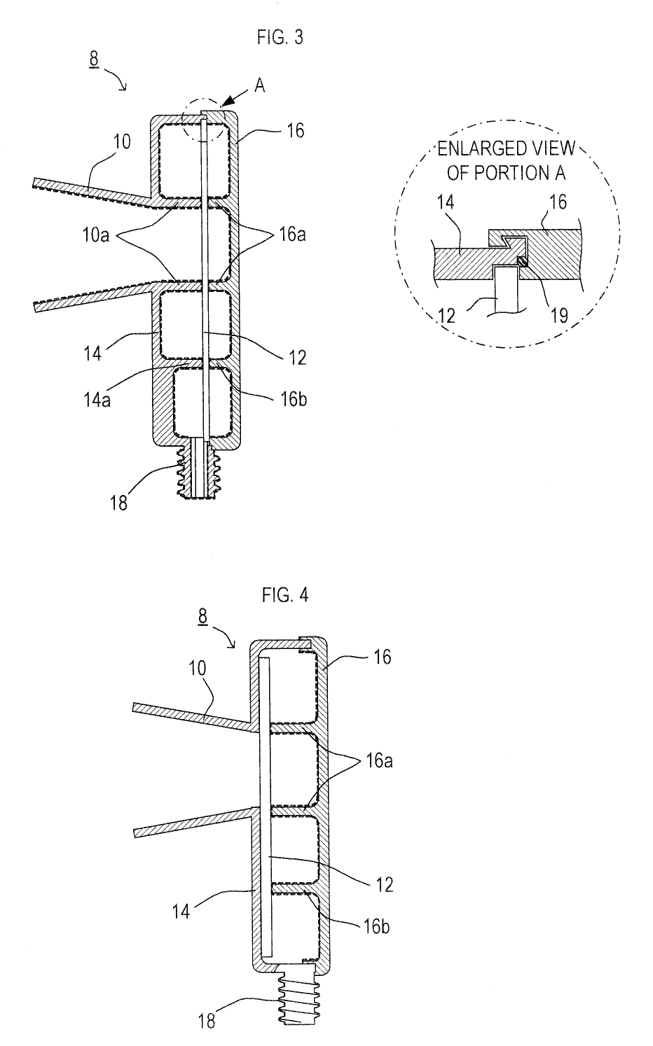

FIG. 1 is a perspective view showing a constitution of a receiving antenna according to the embodiment of the present invention. FIG. 2 is an exploded perspective view showing a constitution of a satellite broadcast receiving converter (hereinafter, referred to simply as a converter) provided in the receiving antenna. FIG. 3 is a sectional view of the converter.

The receiving antenna 2 of the present embodiment is used for receiving a radio wave in ten and several GHz band transmitted from a broadcast satellite (BS) or a communication satellite (CS). As shown in FIG. 1, the receiving antenna 2 includes a parabolic reflector 4 and a converter 8 disposed at a focal position of the parabolic reflector 4 via an arm 6.

The converter 8 receives a radio wave collected by the parabolic reflector 4, then converts the received signal to an intermediate frequency signal of one to several GHz band, and outputs the converted signal. As shown in FIG. 2, the converter 8 includes a feedhorn 10, a circuit board 12, a first case member 14, and a second case member. The feedhorn 10 receives a radio wave reflected and converged by the parabolic reflector 4. A converting circuit, which receives the broadcast satellite radio wave and converts the received signal to an intermediate frequency signal, is formed on the circuit board 12. The first case member 14 is integrally formed at a back end of the feedhorn 10 to support and position the circuit board 12 at the back end of the feedhorn 10. The second case member is disposed on a side opposite to the feedhorn 10 of the first case member 14 and holds the circuit board 12 together with the first case member 14.

The feedhorn 10 and the first case member 14 are integrally formed of synthetic resin. As shown by the dotted lines in FIG. 3, a conductive layer is formed on the inner side surface of the feedhorn 10 which serves as a waveguide path, and on the inner side surface facing the circuit board 12 of the first case member 14, by plating. The metal plating is conducted by forming a layer of copper by nonelectrolytic plating using copper first. Thereafter, a nickel layer or a chromium layer is formed on the layer of copper by electrolytic plating.

As shown in FIG. 3, a hollowed connector portion 18 which constitutes an external conductor of an F-type connector for connecting a coaxial connector is integrally formed on a lower side wall of the first case 14. A conductive layer is formed also on the inner side surface and on the outer side surface of the connector portion 18, by metal plating. A connecting terminal for inserting a center conductor of the coaxial cable is accommodated in the connector portion 18 via a cylindrical insulating member. An output path of a receiving signal formed on the circuit board 12 is connected to the connecting terminal.

The second case member 16 is formed of synthetic resin as in the first case member 14. A conductive layer is also formed on the inner side surface facing the circuit board 12 of the second case member 16 by metal plating.

As shown in FIG. 2, a circular support wall 16a and a support wall 16b are provided in a protruding manner on the inner side surface of the second case member 16. The circular support wall 16a has substantially the same diameter with the back end 10a of the feedhorn 10. The support wall 16b supports the circuit board 12 around the support wall 16a.

The back end 10a of the feedhorn 10 protrudes further backward than an outer wall of the first case member 14 on the feedhorn 10 side, so as to be able to hold the circuit board 12 with the circular support wall 16a provided in a protruding manner on the inner side surface of the second case member 16. Moreover, on the inner side surface of the first case member 14, a support wall 14a for holding the circuit board 12 with the support wall 16b provided in a protruding manner on the inner side surface of the second case member 16 is provided in a protruding manner (see FIG. 3).

Side walls of the first case member 14 and the second case member 16 are formed to be engaged with each other at their opening end sections, as shown in an enlarged view of a portion A in FIG. 3. A waterproof packing member 19 is provided at the engagement section in order to keep rain water from entering inside.

As above, in the converter 8 of the present embodiment, the converter case for accommodating the circuit board 12 is constituted of the two case members of the first case member 14 and the second case member 16. Moreover, the first case member 14 is integrally formed with the feedhorn 10.

Accordingly, the converter 8 of the present embodiment is largely constituted of three members, that is, the first case member 14 with which the feedhorn 10 is integrally formed, the circuit board 12, and the second case member 16 that holds the circuit board together with the first case member 14. As compared to a conventional satellite broadcast receiving converter, the number of components can be reduced. Weight reduction and cost reduction of the satellite broadcast receiving converter can be achieved.

Also in the present embodiment, the feedhorn 10 and the first case member 14, and the second case member 16, are formed of synthetic resin, respectively. By plating the inner side surface with metal, a receiving function of a satellite broadcast radio wave by the feedhorn 10 and a shielding function of the circuit board 12 by the first case member 14 and the second case member 16 are achieved. Weight of the satellite broadcast receiving converter can be all the more reduced.

Moreover, in the present embodiment, the external conductor of the F-type connector is integrally formed with the first case member 14. Thus, there is no need to separately attach an ordinary F-type connector of a single body to the first case member 14. Thereby, the number of components is reduced, so that weight reduction and cost reduction of the satellite broadcast receiving converter can be achieved.

One embodiment of the present invention has been described in the above. It is to be noted, however, that the present invention is not limited to the above-described embodiment, but can take various modes without departing from the gist of the present invention.

For example, in the above-described embodiment, the first case member 14 integrally formed with the feedhorn 10, and the second case member 16, are respectively formed of synthetic resin. Only the inner side surfaces thereof are plated with metal. However, outer surfaces of the feedhorn 10, the first case member 14, and the second case member 16 may be plated with metal as well, or one or both of the first case member 14 integrally formed with the feedhorn 10, and the second case member 16, may be formed by forging such as by press working a metal plate.

Even if the feedhorn 10 and the first case member 14, or the second case member 16, are formed by forging, weight reduction of the converter 8 can be achieved as compared to the case of forming these components by casting.

In the case of integrally forming the feedhorn 10 and the first case member 14 such as by press working a metal plate, the first case member 14 integrated with the feedhorn 10 and the connector portion 18 can be manufactured by pluralizing the steps of press work. However, as shown in FIG. 4, it is unable to provide the support wall 14a for supporting the back end 10a of the feedhorn 10 and the circuit board 12 in a protruding manner on the inner side surface of the first case member 14. In this case, the circuit board 12 can be directly secured to the inner side surface of the first case member 14.

The converter 8 shown in FIG. 4 represents a case in which the second case member 16 is made of synthetic resin. In case that not only the first case member 14 but also the second case member 16 is formed by forging, it is difficult to provide the support walls 16a, 16b on the inner side surface in a protruding manner. In this case, it is necessary to separately provide a member for positioning the circuit board 12 inside the case members.

What is claimed is:

1. A satellite broadcast receiving converter comprising:
a feedhorn to which a satellite broadcast wave is input;
a circuit board on which a converting circuit to convert the satellite broadcast wave to a receiving signal is formed; and
a converter case disposed on a back end side of the feedhorn to support the circuit board,
the converter case being comprised of two case members configured to cover and shield front and back surfaces of the circuit board, and to be able to hold the circuit board, and
a first case member of the two case members being integrally formed with the feedhorn.

2. The satellite broadcast receiving converter according to claim 1 wherein the feedhorn and the support case are integrally formed of synthetic resin, and at least an inner side surface of the feedhorn and an inner side surface facing the circuit board of the first case member are plated with metal.

3. The satellite broadcast receiving converter according to claim 1 wherein the first case member and the feedhorn are integrally formed by forging.

4. The satellite broadcast receiving converter according to claim 1, wherein at least an inner side surface facing the circuit board of a second case member of the two case members is formed of synthetic resin plated with metal.

5. The satellite broadcast receiving converter according to claim 1, wherein a second case member, which is the other of the two case members of the shield case, is formed by forging.

6. The satellite broadcast receiving converter according to claim 1, wherein an external conductor of a coaxial connector for outputting a received signal from the circuit board is integrally formed with the first case member integrally formed with the feedhorn.
